(19) United States
(12) Patent Application Publication
(10) Pub. No.: US 2010/0243545 A1
(43) Pub. Date: Sep. 30, 2010

(54) Positive displacement motor and pumping apparatus

(76) Inventor: Roger A. Benham, San Diego, CA (US)

Correspondence Address: Hoffman, Wasson & Gitler, P.C., Suite 522, 2461 South Clark Street, Arlington, VA, 22202, US

(21) Appl. No.: 12/659,835

(22) Filed: Mar. 23, 2010

Related U.S. Application Data
(60) Provisional application No. 61/202,675, filed on Mar. 26, 2009.

(51) Int. Cl. B01D 69/14; B01D 61/32

(52) U.S. Cl. 210/137; 210/321.66; 210/149

(57) ABSTRACT

A pressure driven apparatus comprising a housing, at least one flexible membrane located within the housing so as to divide the interior of the housing into a plurality of chambers, one or more inlets through which a pressurised fluid enters the housing and one or more outlets through which the pressurised fluid exits the housing, and wherein the membrane is adapted for connection to a drive member such that movement of the pressurised fluid within the housing results in the membrane imparting a force to the drive member.

### CROSS-REFERENCE TO RELATED APPLICATION

This application claims the benefit of the filing date of U.S. provisional patent application Ser. No. 61/202,675, filed Mar. 26, 2009.

### FIELD OF THE INVENTION

The present invention relates to a pressure driven apparatus. In particular, the present invention relates to a pressure driven apparatus that functions by making use of a pressure differential on opposing sides of a membrane to produce a rotational power output. The pressure differential could be generated by any number of sources including pneumatics, combustion gases, hydraulics, head pressure from a column of water, or pressure differentials created by thermal gradients.

### BACKGROUND OF THE INVENTION

A number of forms of pressure driven motors are known. Pressure driven motors may function on a number of operating principles. However, in some examples, pressure driven motors function through pressure force acting upon a piston in a cylinder which is in turn connected to a crankshaft, a turbine rotor on a rotating shaft, a vane on a rotating shaft, or an impeller mounted on a shaft.

These pressure driven motor designs all suffer from a number of drawbacks, including complex construction, relatively low torque, relatively low displacement for the size of the unit, and the fact that significant damage may be caused to these pressure driven motors if the motor becomes overloaded.

Thus, there would be an advantage if it were possible to provide a pressure driven apparatus (particularly a pressure driven apparatus for a motor) that provides for the improved production of reliable and efficient power and work from potential energy sources. In turn, these advantages provide consumers with cleaner, more environmentally-friendly and more efficient options.

It will be clearly understood that, if a prior art publication is referred to herein, this reference does not constitute an admission that the publication forms part of the common general knowledge in the art in the United States or in any other country.

### SUMMARY OF THE INVENTION

An object of the present invention is to provide a pressure driven apparatus, which may at least partially overcome at least one of the abovementioned disadvantages or provide the consumer with a useful or commercial choice.

In one aspect, the invention resides broadly in a pressure driven apparatus comprising a housing, at least one flexible membrane located within the housing so as to divide the interior of the housing into a plurality of chambers, one or more inlets through which a pressurised fluid enters the housing and one or more outlets through which the pressurised fluid exits the housing, and wherein the membrane is adapted for connection to drive member such that movement of the pressurised fluid within the housing results in the membrane imparting a force to the drive member.

The housing may be of any suitable shape, size or configuration. However, it is preferred that the housing is constructed from a material of suitable strength and rigidity to withstand the pressure changes and/or temperature changes experienced within the housing as the pressurised fluid enters and exits the apparatus. For instance, at least the inner surfaces of the housing may be fabricated from ceramics, composite materials or nanotechnology materials.

The membrane may be of any suitable construction. However, in a preferred embodiment of the invention, the membrane is fabricated from a flexible material. In addition, it is preferred that the membrane is fabricated from a pressure-resistant material, such that changes in the pressure inside the housing do not cause the membrane to burst or rupture. For instance, the membrane may be fabricated from plastic, such as high density plastic, rubber, metal or the like, or any combination thereof. The membrane may be linear, tubular or the like in construction.

Importantly, the membrane will typically be of a fixed length and with a higher tensile strength with minimum elasticity. It is also preferable that one end of each of the membranes or a portion of each of the membranes is fixed relative to a portion of the housing (such as an inner surface of the housing). In this manner, injection of the pressurised fluid will preferably cause deformation of the shape of the membrane and because one end or portion of the membrane is fixed relative to the housing, an opposite end of the membrane will move towards the point to which one end of the membrane is fixed to the housing.

In some embodiments of the invention, the membrane may be provided with reinforcement to increase the strength of the membrane. Any suitable reinforcing material, such as cords, strips, ropes, cables, wires, bars, rods, corrugated materials, layered materials or the like (both metallic and non-metallic) may be used. Reinforcement may be located through the entire membrane or only in particular locations, such as the area at which the pressurised fluid enters the apparatus and impacts directly upon the membrane.

Preferably, the membrane is adapted for connection to the drive member, such as, but not limited to, a crankshaft or a piston at a first end, that is the end opposite the fixed end. In preferred embodiments of the invention, the second end of the membrane is adapted for connection to the housing. Preferably, the second end of the membrane is adapted for connection to an inner wall of the housing. It is envisaged that the second end of the membrane will be securely held against the inner wall of the housing, although it is preferred that the engagement between the membrane and the housing is a removable engagement so that the membrane may be removed from the housing for repair of replacement.

The membrane may be connected directly to the drive member. This is particularly the case if only a single membrane is in use. In other embodiments of the invention (and particularly those in which multiple membranes are present), the membranes may be connected to the drive member via a connecting member. For instance, two or more membranes may be connected to a common connecting member, such as a yoke, the yoke being connected to the drive member. In this way, consistent and simultaneous force may be applied to the drive member by all of the membranes.

Preferably, when the apparatus comprises a single membrane, it is preferred that the apparatus comprises a single inlet and a single outlet. In some embodiments, the inlet and the outlet may be the same aperture. Alternatively, a separate inlet and outlet may be provided. When more than one membrane is present, one or more inlets and/or outlets may be provided for each membrane.

In use, a pressurised fluid (such as a pressurised gas or pressurised liquid) is injected into the housing through the one or more inlets. As the fluid enters the housing, the membrane is displaced due to the pressure applied by the pressurised fluid, and the resulting pressure differential between adjacent chambers within the housing. Movement (such as by flexing) of the membrane imparts a force to the drive member. Subsequent to this, the pressurised fluid may then be released from the housing through the one or more outlets. Continued movement of the drive member (for instance, rotational movement, particularly rotational momentum) results in a movement of the membrane back to (or close to) their original position.

In embodiments of the invention in which the membrane is tubular, pressurised fluid may be forced into the interior of the tubular membrane, causing the membrane to expand outwardly. In a preferred embodiment, the tubular membrane expands to seal against the inner surface of the housing. In this embodiment of the invention, the tubular membrane may be provided with sealing means (for instance, one or more O-rings, gaskets or the like) that enhance the sealing of the tubular membrane against the inner surface of the housing.

In an alternative embodiment of the invention, flexing of the membranes may be achieved through a pressure differential caused by temperature gradients between adjacent chambers in the apparatus. For instance, one chamber may be supplied with fluid having a first temperature, while the second chamber may be supplied with a fluid having a temperature greater or less than the temperature of the fluid in the first chamber. In this embodiment of the invention, a separate heat transfer apparatus may be used to cause contraction and expansion of the fluid and therefore flexing of the one or more membranes. Any suitable device may be used to achieve this, such as, but not limited to, a Stirling engine or similar device.

The flow of pressurised fluid into the apparatus may be controlled using any suitable technique. For instance, valves may be provided on the inlets and/or outlets in order to control the flow and timing of the flow of pressurised fluid into and out of the apparatus. Alternatively, the pressurised fluid may be supplied from a fluid source (such as a gas bottle, fluid tap or the like on a timed basis so that fluid only flows into the apparatus during predetermined points in the operational cycle. In embodiments of the invention in which valves are present, any suitable form of valve may be used.

While the flow of pressurised fluid causes movement of the membrane (and therefore, the imparting of a force to the drive member), further force may be imparted to the drive member through the membrane via the use of one or more timing members adapted to act upon the one or more membranes. In this embodiment, the one or more timing members may be adapted to force the one or more membranes against an inner surface of the housing and create a pinch point (seal) that also serves to take up slack in the membrane. The action of the one or more timing members against the membrane causes a timing affect where the tension in the flexible membrane transmits force to the rotating member at the optimum time and for the optimum duration within the cycle.

In a preferred embodiment of the invention, the one or more timing members are adapted for rotation. For instance, the one or more timing members may comprise cams adapted to time the imparting of a force to the drive member. In some embodiments, each of the one or more membranes may be acted upon by one or more timing members.

In embodiments of the invention in which rotating timing members are present, the rotation of the timing members to certain positions in their rotation may further serve to permit the flow of pressurised fluid out of the apparatus through the one or more outlets. In this embodiment, the rotation of the timing members may push the pressurised fluid out of the apparatus through the one or more outlets, or, alternatively, the rotation of the one or more timing members may open a flow path to the one or more outlets for the pressurised fluid by releasing the one or more membranes from the pinch point created when the timing members force the one or more membranes against the inner surface of the housing, or against another membrane. Still further, the movement (for instance, rotational movement) of the drive member may result in applying a force (for instance, a tensive force) to the membrane which may open a flow path to the one or more outlets for the pressurised fluid.

It is envisaged that the force imparted by the one or more membranes to the drive member could be a linear force, such as that required to drive a piston. Alternatively, the drive member may be adapted to rotate, such that the force imparted by the movement of the one or more membranes results in the rotation of the drive member. Thus, in this embodiment of the invention, the drive member may be a shaft, such as, but not limited to, a crank shaft. In some embodiments of the invention, the drive member may be used to drive a motor or the like, although an artisan possessing ordinary skill in the art will understand that the drive member could be used to drive any suitable device.

In another aspect, the invention resides broadly in a pressure driven apparatus comprising a housing, a flexible tubular membrane having a hollow center located within the housing so as to divide the interior of the housing into a plurality of chambers, one or more inlets through which a pressurised fluid is injected into the chamber and one or more outlets through which the pressurised fluid exits the housing, and wherein the injection of the pressurised fluid causes the flexible tubular member to expand and impart a force to a drive member.

Preferably, the expansion of the flexible tubular member causes the flexible tubular member to seal against inner surface of the housing.

In a preferred embodiment of the invention, the flexible tubular member may be provided with sealing means for enhancing the sealing of the flexible tubular member against the inner surface of the housing and/or reinforcement means.

Any suitable sealing means may be used, such as, but not limited to, O-rings, gaskets or the like. Similarly, any suitable reinforcement means may be used, such as, but not limited to cords, strips, ropes, cables, wires, bars, rods, corrugated materials, layered materials or the like (both metallic and non-metallic), or any combination thereof.

Various configurations, modifications, and additions can be added to modify and improve the operating characteristics of this invention. For example, multiple membranes can be configured together in parallel, opposing, in series, in stages, or radially. A variety of cam configurations or no cam at all, can be used to affect the timing of the power and exhaust cycles. A wide varied of membrane materials could be used for different applications.

### BRIEF DESCRIPTION OF THE DRAWINGS

Various embodiments of the invention and appurtenances will be described with reference to the following drawings wherein like objects are assigned the same reference numeral, in which:

FIGS. 1A-1D show sectioned views of a pressure driven apparatus according to an embodiment of the invention during an operational sequence of the apparatus;

FIG. 2 shows a sectioned view of a pressure driven apparatus according to an embodiment of the invention;

FIGS. 3A-3C show sectioned views of a pressure driven apparatus according to an alternative embodiment of the invention during an operational sequence of the apparatus;

FIG. 4 shows a cross sectional view of a flexible membrane in tubular form according to an embodiment of the invention;

FIG. 5 shows a cross sectional view of a flexible membrane and a timing exhaust cam according to an embodiment of the invention;

FIG. 6 shows a perspective view a pressure driven apparatus according to an embodiment of the invention;

FIG. 7 shows a perspective view a pressure driven apparatus according to an embodiment of the invention;

FIGS. 8A-8B show sectioned views of a pressure driven apparatus according to an embodiment of the present invention during an operational sequence of the apparatus; and

FIG. 9 shows a sectioned view of a pressure driven apparatus according to an embodiment of the invention.

### DETAILED DESCRIPTION OF THE PREFERRED EMBODIMENTS

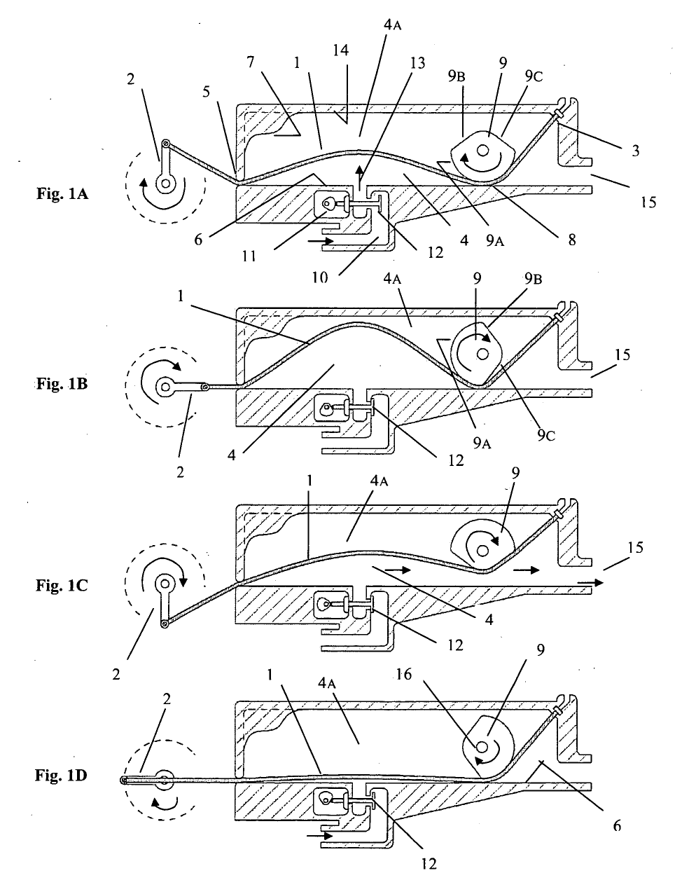

FIG. 1 shows sectioned views of one embodiment of the device at four ninety degree increments of the 360 degree crankshaft rotational cycle, including the power portion (FIG. 1A), the top-dead-center portion (FIG. 1B), the exhaust portion (FIG. 1C), and bottom-dead-center (FIG. 1D) portion of the rotational cycle.

In reference to FIG. 1A, a flexible membrane 1 with two ends has one end attached to a crankshaft 2 (mechanical supports for the crankshaft are not shown) and the other end is attached to a fixture point 3 within a housing or crankcase 14. In between the crankshaft 2 and the fixture point 3 there is an expansion zone 4 provided within the housing created by the annulus formed between membrane 1, a front circumferential seal 5, a bottom plate 6, two sidewalls (7—not fully shown in order to show internal parts), and a pinch zone 8 created by the action of an exhaust cam 9 pinching against the bottom plate 6.

The exhaust cam 9 is provided with three outer bearing lobe surfaces 9A, 9B and 9C. The approximate hemispheric surface 9A bears against the membrane 9A to pinch against the bottom plate 6 in the stroke position shown in FIG. 1A. Surfaces 9B and 9C are approximately equal to each other in length and will bear against the membrane 1 as will be further explained.

FIG. 1A shows the invention at half way through the power stroke. At this point in the rotational cycle pressurized fluid which has entered and continues to enter through a supply port 10 and is being injected into the sealed expansion zone 4 by means of an injection cam 11 opening an injection valve 12 allowing entry of pressurized fluid into the expansion zone 4 through an injection port 13. The pressurized and or expanding fluid in the expansion zone 4 pushes against the membrane 1 backed by the typically lower atmospheric pressure within the crankcase 14 in section 4A on the side of the membrane 1 opposite the expansion zone 4 and causes tension in the membrane 1 causing it to pull on the crankshaft 2. It is noted that any controlled fluid injection method could be used including electronic type, mechanical, hydraulic, or other types of electro-mechanical means of on-off fluid injection.

FIG. 1B shows the invention at bottom-dead-center of the crankshaft 2 stroke. The injection valve 12 is closed and the exhaust cam lobe 9 is immediately poised to allow the membrane 1 to open to depressurize the expansion zone 4 through exhaust port 15 taking some tension off of the membrane 1. FIG. 1B illustrates the lobe 9C immediately before it will abut on the main frame 1.

FIG. 1C shows the invention half way through the exhaust stroke section of the rotational cycle. The exhaust cam lobe 9B abuts the membrane 1 and has allowed it to rise and the expansion zone 4 is directly exposed to the exhaust port 15. As the crankshaft 2 continuous around it pulls on the membrane 1 which collapses the expansion zone 4 forcing the exhaust fluids out of the exhaust port 15 as lobe 9A begins to abut the membrane 1.

FIG. 1D shows the invention at top-dead-center of the crankshaft 2 stroke. The injection valve 12 is beginning to open to allow pressurized fluid into the expansion zone 4 to being the power stroke and the exhaust cam lobe 9, which is driven by a cam shaft 16, is beginning to pinch the membrane 1 against the bottom plate 6 to allow the pressurization of the expansion zone 4 and tensioning of the membrane 1 and so on and so forth into another rotational cycle.

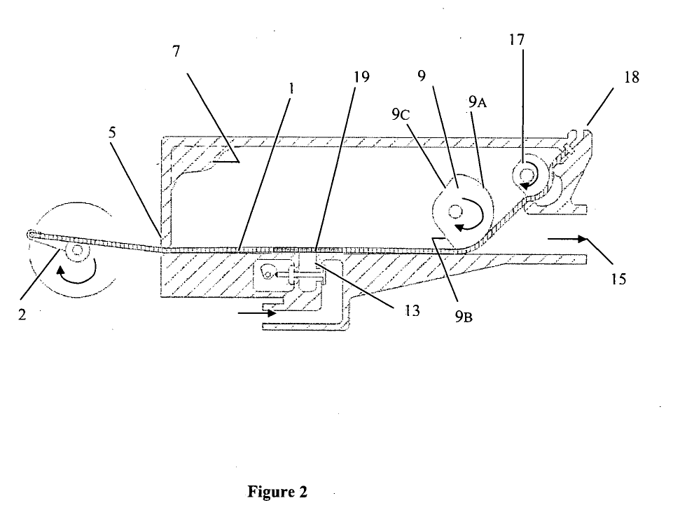

FIG. 2 shows one embodiment of a sectioned view of the invention including an embodiment of an ancillary timing cam 17 installed to change the timing of the pressurized fluid injection into the power stroke of the rotational cycle. In this embodiment, the timing cam 17 is configured to take up slack in the membrane 1 when the crankshaft 2 rotates past top-dead-center. Pressurized fluid is injected after top-dead-center to cause the power stroke to occur during a region of the crankshaft 2 rotation where the tension in the membrane 1 is more tangential and has a larger component of leverage, thereby increasing torque and efficiency of the motor. It is noted that any belt tensioning method could be used to affect the slack and or timing of the membrane 1 closing or opening cycle including electronic, mechanical, hydraulic, rotational, rotating or non-rotating cam, winding spool, second crankshaft, or other types of electro-mechanical means.

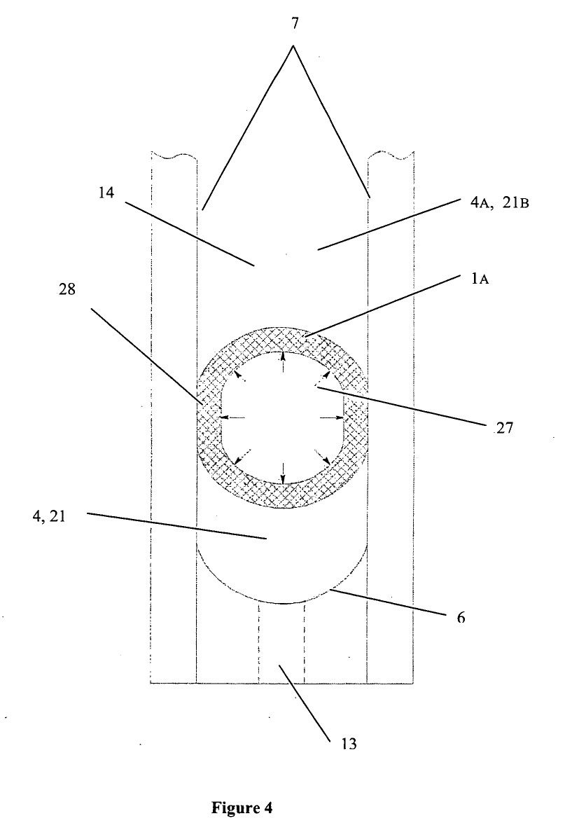

The embodiment shown in FIG. 2 includes a pressure fill port 18 filled by a source of fluid, not shown, that is used to impart pressure into a hollow portion of the flexible membrane 1 improving the sealing characteristics of the membrane, as described in more detail later in FIGS. 4 through 6. FIG. 2 also shows one embodiment including a center reinforcement area 19 of the membrane 1 where aggressive conditions caused by high fluid pressures and velocities exiting the injection port 13 can impinge and cause wear problems. The center reinforcement area 19 is constructed from material to prevent or impede wear problems from occurring.

It is noted that the embodiment shown in FIG. 2 can be configured to change the stroke height of the flexible membrane 1 in the expansion zone 4. For example, there are two stroke lengths associated with this invention including L1, the stroke length of the rotating crankshaft 2, and, L2 the maximum height that the flexible membrane 1 achieves when the rotational cycle is at bottom dead center of the rotational cycle (FIG. 1B). It is further noted that the stroke length L2 can be changed by moving the front circumferential seal 5 location forward and back from the crankshaft 2 center and the cam 9 location. This allows for performance and output characteristic of the invention to be changed, either in a fixed method or on-the-fly. In general it is desirable to have L2 longer that L1. With L2 longer than L1 there are benefits associated with the higher hoop stress, or tension, on the flexible membrane. Where in this example hoop stress is described as T (hoop stress or tension)=P (fluid pressure in the expansion zone 4)×r (radius or arc) divided by t (thickness of the membrane). Another description of the tension in the membrane is defined in terms of beam loading mechanics where the force of the pressure is compounded by the beam loading placement toward the middle of L2, where F (force or tension on the membrane is a function of the P (fluid pressure in the expansion zone 4) multiplied by the inverse of sin ø (where ø is generally the angle between the membrane and the horizontal base plate 6).

Again, referring to FIG. 2, it is also noted that the power stroke and exhaust stroke timing characteristics can be changed by offsetting the main journal of crankshaft 2 either up or down from the plane of the of the horizontal base plate 6.

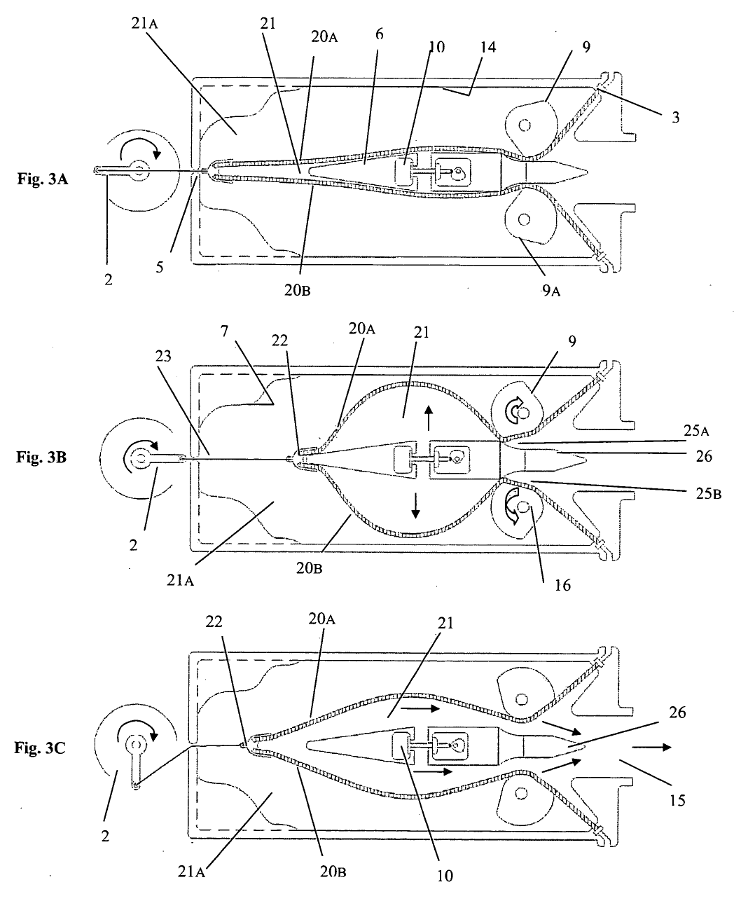

FIG. 3 shows sectioned views of a preferred embodiment of the invention where two opposing membranes 20A and 20B create a continuous double expansion zone 21 between members 20A and 20B. Three regions of the crankshaft 2 rotation are shown, including top-dead-center (FIG. 3A), bottom-dead-center (FIG. 3B), and a point of rotation half way through the exhaust stroke (FIG. 3C).

The principal of operation of the embodiment shown in FIG. 3 is basically the same as that shown in FIG. 1. As shown in FIG. 3A and FIG. 3B, the two opposing membranes 20A and 20B are joined together at a travelling yoke 22 assembly that maintains a dynamic leak free seal between the pressurized double expansion zone 21 and the non-pressurized and vented zone in the crankcase 14 outside of the double expansion zone 21. A flexible connecting membrane 23 is connected between the crankshaft 2 and the travelling yoke 22. The tension on the connecting membrane 23 is double the tension on the opposing membranes 20A and 20B. The connecting membrane 23 can be routed to the crankshaft circuitously through a series of cables and pulleys. The configuration of the two opposing membranes 20A and 20B has inherent balancing benefits, where the acceleration and deceleration forces caused by the up and down components of motion cancel each other out.

In the embodiment shown in FIG. 3, and partially shown in FIG. 3B, a first offset area 25A is provided between an exhaust tailpipe 26 and membrane 20A, and a second offset area 25B provided between the exhaust tail pipe 26 and the membrane 20B. The offset area 25A coincides with the cam 9, and the offset area 25B coincides with a second cam 9A. The offset areas 25A and 25B affect the timing of the injection of the pressurized fluid beyond the top-dead-center point of the crankshaft rotation, similar to the timing cam 17 shown in FIG. 2. The placement of the offset areas 25A and 25B and the length of the lobes on cams 9 and 9A can be configured to create many different injection and exhaust timing scenarios. As shown in FIG. 3B, the cams 9 and 9A rotate in opposite directions as depicted by the arrows associated with each of the cams 9 and 9A.

FIG. 3C shows one embodiment of the placement of the aerodynamically shaped exhaust tail 26 in the exhaust port 15 that produces a lower flow resistance of the exhaust fluids. In the embodiment shown, the high pressure supply inlet port 10 enters from the side of the base plate 6. It is noted that the base plate 6 can be simplified and omitted entirely with the configuration of two opposing membranes 20A and 20B. The sealing action of the cam 16 can occur with no base plate by the cams 9 and 16 pressing and pinching the opposing flexible membranes 1 together. With no base plate 6, the supply inlet port 10 can be configured to enter adjacent or through the exhaust tail 26.

FIG. 4 shows a cross section view of one embodiment of the sealing characteristics of a tubular membrane 1 against the sidewalls 7 of the expansion zone (4 or 21), and the base plate 6. In this embodiment, pressure injected into the tubular membrane 1A causes a radial sealing force 27 to cause a plastically formed sealing area 28 between the pressurized expansion zone (4 or 21) and the non-pressurized crankcase area 14. The sealing area 28 can be augmented with the use of molded shapes, groves, o-rings, and or sealing inserts. This sealing area 28 would be comprised with materials that produce the lowest possible coefficient of friction. It is noted here that the flexible membrane 1A can be configured to have a dispersement of reinforcement, such as metal or high strength non-metallic cords, strips, ropes, roves, corrugated or crinkled materials, sandwich structures, bonded multi-layered material, unbonded multi-layered material (allowing slippage between layers), nanomaterials, cables or wires, to increase the tensile strength and elastic modulus of the flexible membrane 1A.

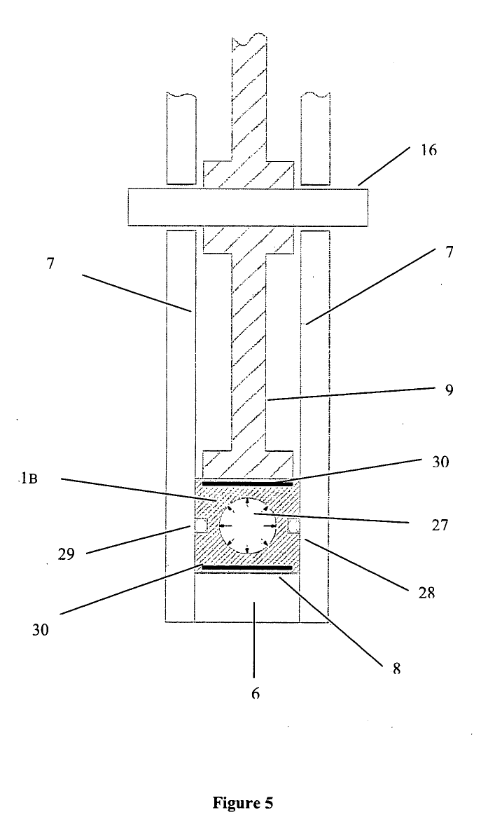

FIG. 5 shows a cross section view of one embodiment of the exhaust cam 9 creating a seal between a rectangular shaped membrane 1B, the sidewalls 7, and the bottom plate 6 at the pinching zone 8. In this embodiment, forces from both the exhaust cam 9 and the sealing force 27 from pressure injected into a hollow section of the rectangular shaped membrane 1B together cause a plastically formed sealing area 28. In this embodiment the rectangular shaped flexible membrane 1B has an o-ring type sealing mechanism 29, and has steel band reinforcement 30 either molded into and/or mechanically bonded and mounted onto the flexible membrane 1B. The sidewalls 7 are preferably a low friction material with desirable heat transfer characteristics and could include ceramics, composites, or nanotechnology materials. In this embodiment the area of the exhaust cam 9 is openly exposed toward the housing or crankcase 14 (not shown) and can be splash lubricated or pressure lubricated through oil pumped from the cam 16.

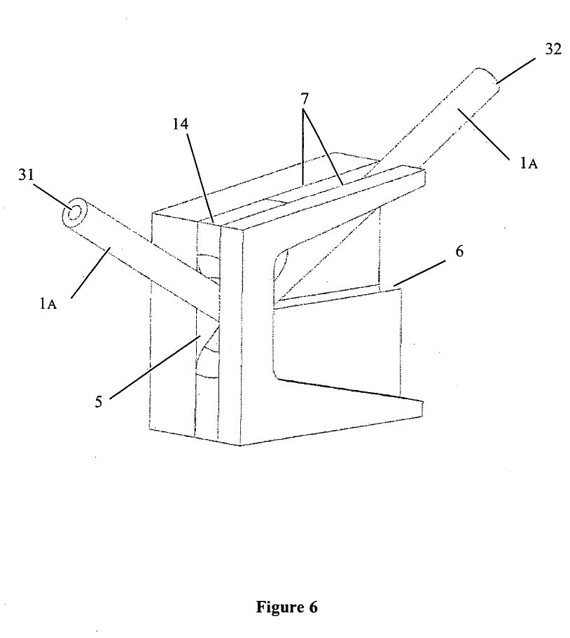

FIG. 6 shows a three dimensional cut-away view from the crankshaft side of one embodiment of a pressure tight dynamic circumferential seal 5 made between the head plate of the housing or crankcase 14 and a tubular shaped flexible membrane 1A. This seal is referenced in the description of FIG. 1. In this embodiment a front circumferential seal 5 is made though the housing or crankcase 14 allowing the required back and forth movement of the tubular membrane 1A to transfer force to the crankshaft 2, while maintaining a pressure tight seal between the non-pressurized crankcase area 4A and the pressurized expansion zone 4. Also shown in FIG. 6 are the side walls 7, the base plate 6, the crankshaft end 31 of the tubular membrane going to the crankshaft 2 (not shown), and the fixture end 32 of the tubular membrane going toward the fixture end 3 (not shown). In this embodiment the tubular membrane 1 is pressurized to enhance the sealing characteristics of the dynamic front circumferential seal 5.

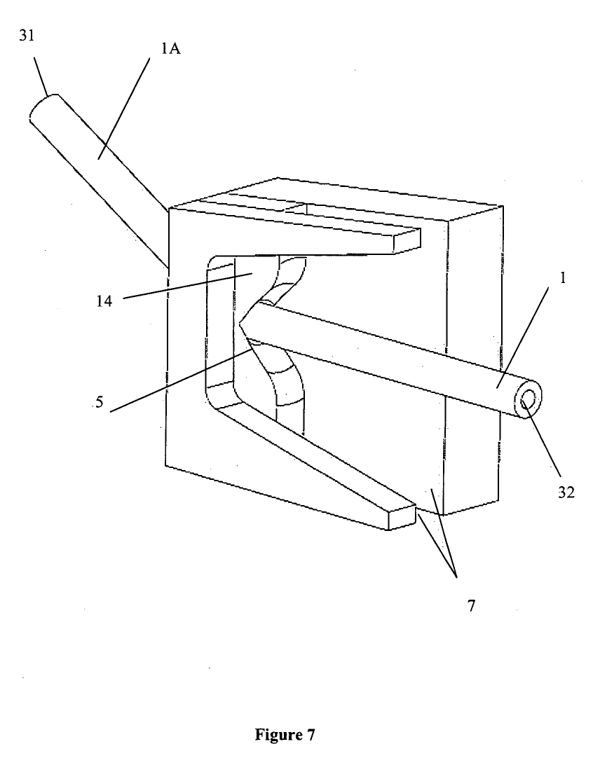

FIG. 7 is a three dimensional view of one embodiment of a pressure tight dynamic seal 5 made between the head plate of the crankcase 14 and a tubular shaped flexible membrane 1 as viewed from the from the flexible membrane 1 side of the head plate part of the crankcase 14. Also shown in FIG. 7 are the side walls 7, the crankshaft end 31 of the tubular membrane going to the crankshaft 2 (not shown), and the fixture end 32 of the tubular membrane going toward the fixture point 3 (not shown). In this embodiment the tubular membrane 1A is pressurized to enhance the sealing characteristics of the dynamic front circumferential seal 5.

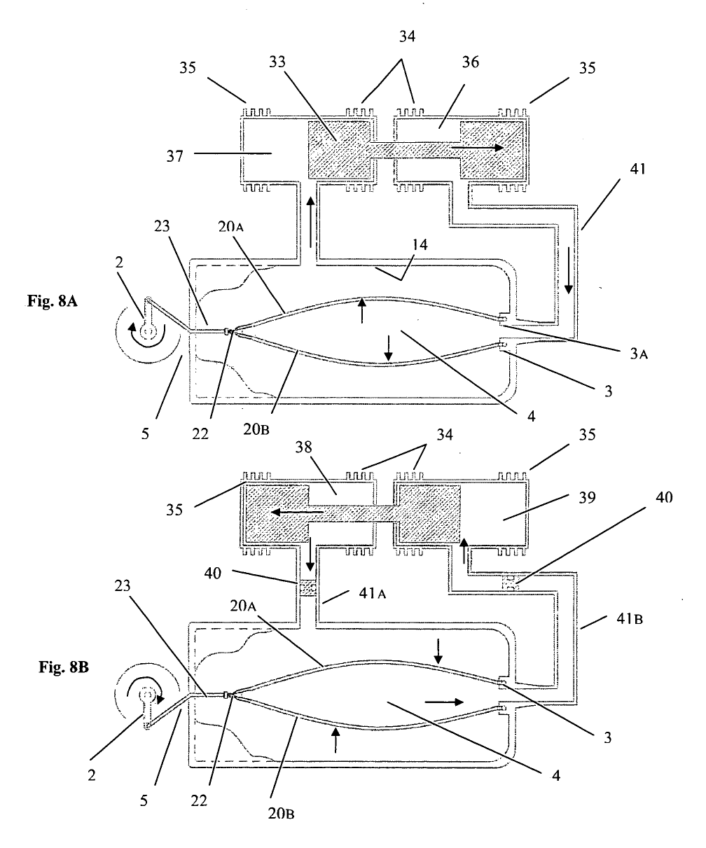

FIGS. 8A and 8B show sectioned views of one embodiment of the invention with two opposing membranes 20A and 20B fixed at one end by fixture points 3 and at the second end to a yoke 22 assembly, then to a tubular flexible connecting membrane 23 and then to the crankshaft 2 through a dynamic circumferential seal 5. In this embodiment the source of the pressure differential is a thermal gradient caused by a type of Stirling engine, where a displacement piston 33 moves gas back and forth between hot sections 34 and cold sections 35, creating expansion and contraction to and from the described invention by way of pressure carrying conduits 41 in a cyclical fashion that corresponds to the power and return cycle of the crankshaft 2.

FIG. 8A shows one embodiment of the motor in the power stroke of the cycle where heat input from the hot section 34 causes the gas in a hot end chamber 36 to expand causing forced expansion of the expansion zone 4 side of the flexible membranes 20A and 20B, while cooling in a cold end chamber 37 is contracting the gas on the crankcase 14 side of the membrane, where both the expansion and contracting actions of the gas cause the tension on the flexible membrane 20A and 20B and torque on the crankshaft 2.

FIG. 8B shows one embodiment of the motor in the return stroke, or nonpower stroke, where heat input from the hot section 34 causes the gas in a second hot end chamber 38 to expand causing forced expansion of the crankcase 14 side of the membrane, while cooling in the second cold end chamber 39 is contracting the gas on the expansion zone 4 side of the membrane, resulting in less energy required to collapse the expansion zone 4 then used on the power stroke. More energy exerting tension on the membrane 20 and 20B during the power stroke than on the return stoke results in a net output of energy through the crankshaft rotation.

FIG. 8B shows one embodiment where separator diaphragms 40 are configured in conduit circuits 41A and 41B that allow for the separation of fluid from the gas filled Stirling type of engine from the fluid in the crankcase 14 and the expansion zone 4. The use of the separator diaphrams 40 enables the use of separate gases, lubrication oils, or one hundred percent liquid media within the crankcase 14 and expansion zone 4. FIG. 8B shows an embodiment of a tubular flexible connecting membrane 23 that connects the yoke 22 to the crankshaft 2 through a dynamic circumferential seal 5. It is noted that a cam could be configured into a flow-through design where instead of in-and-out flow the fluid is circulated or pumped in one conduit and out another.

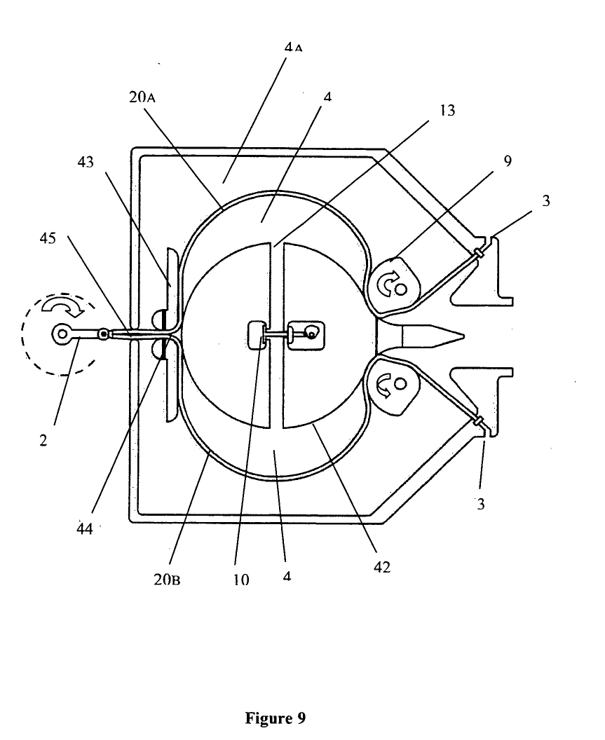

FIG. 9 shows a sectioned view of one embodiment of the invention configured with two opposing membranes 20A and 20B each fixed at one end by fixture points 3 and at the other directly to the crankshaft 2. In this embodiment, the invention in configured with a circular bottom plate 42 and a band guide 43. At the intersection of the opposing flexible membranes 20A and 20B, the band guide 43 forces the two flexible membranes 20A and 20B together to form a dynamic band guide seal 44. The dynamic band guide seal 44 prevents pressurized fluid from the expansion zone 4 from escaping during the operation of the invention. Toward the crankshaft 2 side of the dynamic band seal 44, the flexible membranes 1 are joined or wrapped around the journal of the crankshaft 2. An optional non-sealing band guide 45 is shown between the crankshaft 2 and the band guide seal 44.

FIG. 9 shows the use of the circular bottom plate 42 with a supply port 10 and inlet ports 13 directed to each expansion zone 4. The configuration of a circular bottom plate has the effect of a block and pulley type of motion reduction, where the distance pulled by the crankshaft 2 results in generally one-half the distance moving at the top of the each of the flexible membranes. This configuration results in less tension on the flexible membranes 20A and 20B than the configurations shown in FIGS. 1 through 3. It is noted that numerous valving or fluid supply mechanism could be used instead of the supply port 10 and inlet port 13 configuration, including push-pull valves, rotating valves, diaphragms, or push-pull or rotating cylinder style valves.

The above information describes the general operation of the pressure driven motor apparatus. Unique to the present invention are injection, sealing, and exhaust devices and a relatively long flexible membrane acted on by a pressure differential to produce tension in the membrane and then transferring this tension to a crankshaft to produce a usable rotating power output. The pressure differential can be obtained from many sources.

Some benefits include:
A non-linear volumetric expansion zone.
Positive displacement expansion zone
More effective transference of pressure forces into linear or rotational movement.
Simple construction.
High displacement for unit size.
High torque high rpm potential.
Variable stroke length
Conducive to lubrication on all moving components
Adjustable power and exhaust stroke.
Inherent cooling by driving fluid that cools the motor.
Cannot be overloaded. Motor can be loaded to a complete stop without causing damage.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

What is claimed is:

1. A pressure driven apparatus comprising a housing, a drive member, at least one flexible membrane located within the housing so as to divide the interior of the housing into a plurality of chambers, one or more inlets through which a pressurised fluid enters the housing and one or more outlets through which the pressurised fluid exits the housing, and wherein the at least one membrane is adapted for connection to a drive member such that movement of the pressurised fluid within the housing results in the at least one membrane imparting a force to the drive member.

2. The pressure driven apparatus according to claim 1 wherein the at least one flexible membrane is provided with reinforcement.

3. The pressure driven apparatus according to claim 1, wherein the one or more inlets are provided with valves to control the flow of pressurised fluid into the apparatus.

4. The pressure driven apparatus according to claim 1, wherein the at least one flexible membrane imparts a rotational force to the drive member.

5. The pressure driven apparatus according to claim 1, wherein the drive member is a crankshaft.

6. The pressure driven apparatus according to claim 1, wherein the at least one flexible membrane imparts a linear force to the drive member.

7. The pressure driven apparatus according to claim 6, wherein the drive member is a piston.

8. The pressure driven apparatus according to claim 1, wherein the apparatus further comprises one or more timing members adapted to act upon the at least one flexible membrane so as to enhance the timing of the force imparted to the drive member.

9. The pressure driven apparatus according to claim 8, wherein the one or more timing members comprise cams.

10. The pressure driven apparatus according to claim 8, wherein further rotation of the one or more timing members and/or the drive member results in the flow of pressurised fluid out of the apparatus through the one or more outlets.

11. The pressure driven apparatus according to claim 1, wherein the flexing of the at least one flexible membrane is caused by pressure differentials between the plurality of chambers in the housing.

12. The pressure driven apparatus according claim 1, wherein the flexing of the at least one flexible membrane is caused by temperature gradients between the plurality of chambers in the housing.

13. The pressure driven apparatus according to claim 1, wherein the at least one flexible membrane is adapted for connection at one end thereof to an inner surface of the housing.

14. The pressure driven apparatus according to claim 1, wherein the apparatus comprises a pair of flexible membranes.

15. The pressure driven apparatus according to claim 14, wherein the pair of flexible membranes are connected at one end to a connecting member, the connecting member being adapted for connection to the drive member.

16. The pressure driven apparatus according to claim 15, wherein the connecting member is a yoke.

17. The pressure driven apparatus according to claim 14, wherein the one or more inlets through which a pressurised fluid enters the housing are located between the pair of flexible membranes.

18. A pressure driven apparatus comprising a housing, a drive member, a flexible tubular membrane having a hollow center located within the housing so as to divide the interior of the housing into a plurality of chambers, one or more inlets through which a pressurised fluid is injected into the hollow center of the flexible tubular member and one or more outlets through which the pressurised fluid exits the housing, and wherein the injection of the pressurised fluid causes the flexible tubular member to expand and impart a force to the drive member.

19. The pressure driven apparatus according to claim 18, wherein the expansion of the flexible tubular member causes the flexible tubular member to seal against at least one inner surface of the housing.

20. The pressure driven apparatus according to claim 19, wherein the flexible tubular member is provided with sealing means for enhancing the sealing of the flexible tubular member against the at least one inner surface of the housing.

21. The pressure driven apparatus according to claim 18, wherein the flexible tubular member is provided with reinforcement.
